(19) United States
(12) Patent Application Publication
(10) Pub. No.: US 2026/0088227 A1
(43) Pub. Date: Mar. 26, 2026

(54) MULTILAYER CERAMIC CAPACITOR

(71) Applicant: Murata Manufacturing Co., Ltd., Nagaokakyo-shi (JP)

(72) Inventors: Kenichi HAMANAKA, Nagaokakyo-shi (JP); Kota ZENZAI, Nagaokakyo-shi (JP); Yoshihito AKIYAMA, Nagaokakyo-shi (JP); Junichi YOSHINO, Nagaokakyo-shi (JP)

(21) Appl. No.: 19/406,181

(22) Filed: Dec. 2, 2025

Related U.S. Application Data
(63) Continuation of application No. PCT/JP2024/015285, filed on Apr. 17, 2024.

(30) Foreign Application Priority Data
Jun. 12, 2023 (JP) 2023-096218

(51) Int. Cl. H01G 4/232; H01G 4/30

(52) U.S. Cl. CPC H01G 4/2325; H01G 4/30

(57) ABSTRACT

A multilayer ceramic capacitor includes a ceramic base body including dielectric layers and internal electrode layers, first and second main surfaces opposed to each other in a height direction, first and second side surfaces opposed to each other in a width direction, and first and second end surfaces opposed to each other in a length direction, and a terminal electrode on the ceramic base body and connected to a portion of the internal electrode layers. The terminal electrode includes a resin electrode including a resin and a conductive filler. An average particle diameter of the filler is about 5 μm or more. An average aspect ratio of the filler is about 4 or more.

### CROSS REFERENCE TO RELATED APPLICATIONS

This application claims the benefit of priority to Japanese Patent Application No. 2023-096218 filed on Jun. 12, 2023 and is a Continuation Application of PCT Application No. PCT/JP2024/015285 filed on Apr. 17, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Some terminal electrodes of multilayer ceramic capacitors include resin electrodes. Japanese Unexamined Patent Application, Publication No. 2014-160791 describes a resin electrode including copper powder and epoxy resin.

When the terminal electrode includes a resin electrode, the resin electrode can release stress applied to the multilayer ceramic capacitor. This is because cracks occur inside the resin electrode and the stress is released. As a result, the occurrence of cracks in the ceramic base body is reduced or prevented.

However, the conventional resin electrodes have room for improvement in that stress release is not sufficient.

### SUMMARY OF THE INVENTION

Example embodiments of the present invention provide multilayer ceramic capacitors in each of which a resin electrode releases stress more effectively and cracks are less likely to occur in a ceramic base body.

An example embodiment of the present invention provides a multilayer ceramic capacitor which includes a ceramic base body including a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, and terminal electrodes each on the ceramic base body and each connected to some among the plurality of internal electrode layers. Each of the terminal electrodes includes a resin electrode. The resin electrode includes a resin and an electrically conductive filler. An average particle size of the electrically conductive filler is about 5 μm or more. An average aspect ratio of the electrically conductive filler is about 4 or more.

According to example embodiments of the present invention, multilayer ceramic capacitors in each of which a resin electrode releases stress more effectively and cracks are less likely to occur in a ceramic base body are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to an example embodiment of the present invention.

FIG. 2 is a cross-sectional view taken along the line I-I in FIG. 1.

FIG. 3 is a cross-sectional view taken along the line II-II in FIG. 1.

FIG. 4 is a conceptual diagram of a cross section of a terminal electrode according to an example embodiment of the present invention.

FIG. 5 is a conceptual diagram of a cross section of a conventional terminal electrode.

FIG. 6 is a diagram showing a scanning electron microscope image of a cross section of a terminal electrode according to an example embodiment of the present invention.

FIG. 7 is a diagram showing a scanning electron microscope image of a cross section of a conventional terminal electrode.

FIG. 8 is a diagram showing an example of a method for forming a resin electrode according to an example embodiment of the present invention.

### DETAILED DESCRIPTION OF EXAMPLE EMBODIMENTS

Example embodiments of the present invention will be described in detail below with reference to the drawings.

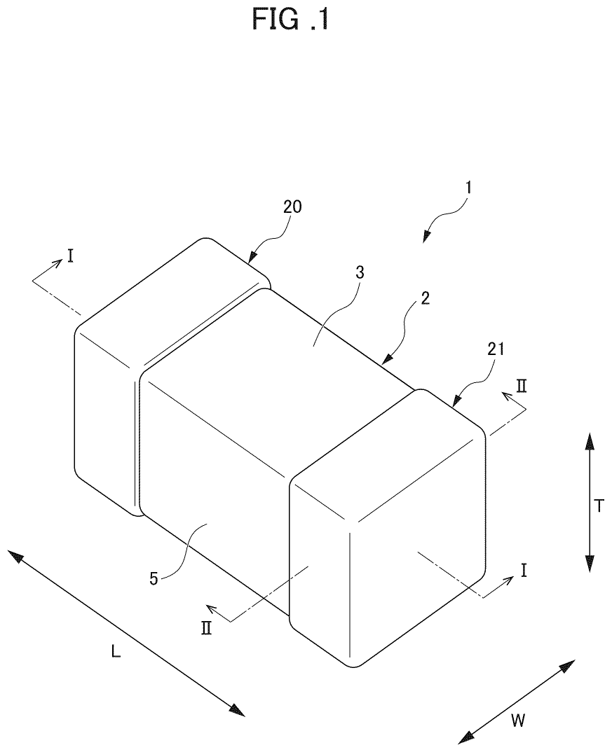

Ab example embodiment of the present invention will be described based on FIG. 1. FIG. 1 is a perspective view of a multilayer ceramic capacitor 1 according to an example embodiment of the present invention. FIG. 1 shows a two-terminal multilayer ceramic capacitor. The multilayer ceramic capacitor 1 of example embodiments of the present invention is not limited to a two-terminal multilayer ceramic capacitor. The multilayer ceramic capacitor 1 may be a multi-terminal multilayer ceramic capacitor, such as a three-terminal capacitor.

The multilayer ceramic capacitor 1 includes a ceramic base body 2 and terminal electrodes. The terminal electrodes include a first terminal electrode 20 and a second terminal electrode 21.

The ceramic base body 2 includes a plurality of laminated dielectric layers and a plurality of laminated internal electrode layers. The ceramic base body 2 has a rectangular or substantially rectangular parallelepiped shape.

In the ceramic base body 2, a direction in which the dielectric layers and the internal electrode layers are laminated is defined as a height direction T. A direction orthogonal or substantially orthogonal to the height direction T is defined as a width direction W. A direction orthogonal or substantially orthogonal to the height direction T and the width direction W is defined as a length direction L.

In the ceramic base body 2, one of the two surfaces opposed to each other in the height direction T is defined as a first main surface 3. The other one is defined as a second main surface 4. In the ceramic base body 2, one of the two surfaces opposed to each other in the width direction W is defined as a first lateral surface 5. The other one is defined as a second lateral surface 6. In the ceramic base body 2, one of the two surfaces opposed to each other in the length direction L is defined as a first end surface 7. The other one is defined as a second end surface 8.

With respect to the cross section of the ceramic base body 2, the cross section along the line I-I in FIG. 1 is referred to as the LT cross section. With respect to the cross section of the ceramic base body 2, the cross section along the line II-II in FIG. 1 is referred to as the WT cross section.

A portion where three surfaces of the ceramic base body 2 intersect is referred to as a corner portion of the ceramic base body 2. A portion where two surfaces of the ceramic base body 2 intersect is referred to as a ridge portion of the ceramic base body 2. It is preferable that the corner portions and the ridge portions are rounded.

The total number of dielectric layers laminated in the ceramic base body 2 is, for example, preferably fifteen or more and 2000 or less. The main material of the dielectric layers is a ceramic material. Examples of the ceramic material include dielectric ceramics including barium titanate, calcium titanate, strontium titanate, calcium zirconate, or the like as a main component. The ceramic material may be a dielectric ceramic in which sub-components such as, for example, manganese compounds, iron compounds, chromium compounds, cobalt compounds, nickel compounds, or the like are added to these main components.

The thickness of each dielectric layer is, for example, preferably about 0.3 μm or more and about 10 μm or less.

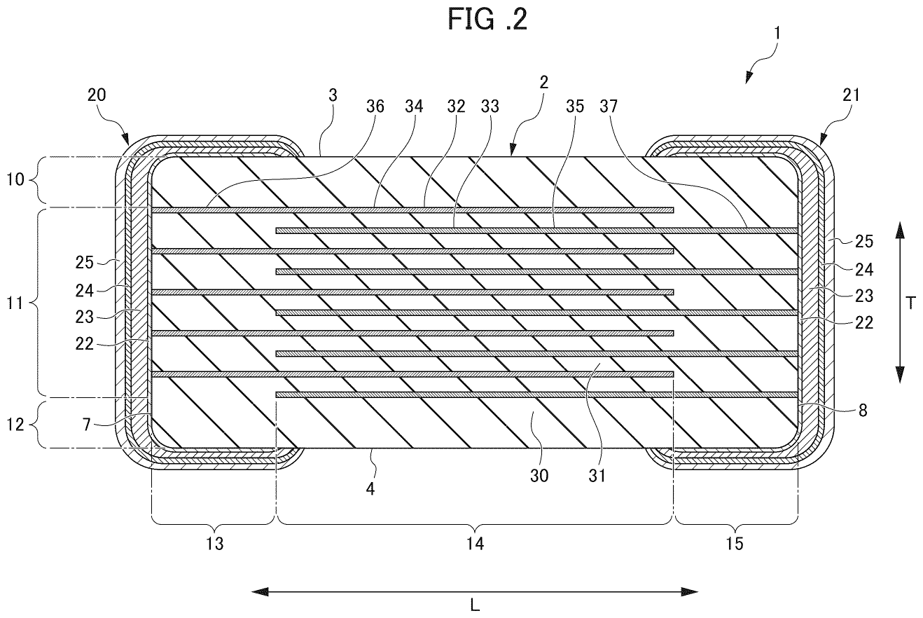

The division of the ceramic base body 2 in the length direction L will be described based on FIG. 2. FIG. 2 is a cross-sectional view taken along the line I-I in FIG. 1. The ceramic base body 2 can be divided into a first main surface-side outer layer portion 10, an effective portion 11, and a second main surface-side outer layer portion 12 in the height direction T.

The first main surface-side outer layer portion 10 is a portion between an internal electrode layer closest to the first main surface 3 and the first main surface 3. The effective portion 11 is a portion where the internal electrode layers are opposed to each other. The second main surface-side outer layer portion 12 is a portion between an internal electrode layer closest to the second main surface 4 and the second main surface 4.

Among the dielectric layers, the dielectric layers provided in the first main surface-side outer layer portion 10 and the second main surface-side outer layer portion 12 are defined as outer dielectric layers 30. Among the dielectric layers, the dielectric layers provided in the effective portion 11 are defined as inner dielectric layers 31.

The size of the ceramic base body 2 is not particularly limited. The length direction dimension L of the ceramic base body is, for example, preferably about 0.2 mm or more and about 10 mm or less. The width direction dimension W of the ceramic base body 2 is, for example, preferably about 0.1 mm or more and about 5 mm or less. The height direction dimension T of the ceramic base body 2 is, for example, preferably about 0.1 mm or more and about 5 mm or less.

The division of the ceramic base body 2 in the length direction L will be explained. The ceramic base body 2 can be divided into a first end surface-side outer layer portion 13, a length direction counter portion 14, and a second end surface-side outer layer portion 15 in the length direction L.

The length direction counter portion 14 refers to a portion where the internal electrode layers are opposed to each other in the height direction T. The first end surface-side outer layer portion 13 refers to a portion between the length direction counter portion 14 and the first end surface 7. The second end surface-side outer layer portion 15 refers to a portion between the length direction counter portion 14 and the second end surface 8.

The length direction counter portion 14 corresponds to the counter electrode portions of the internal electrode layers. The first end surface-side outer layer portion 13 and the second end surface-side outer layer portion 15 correspond to extension electrode portions of the internal electrode layers. The first end surface-side outer layer portion 13 and the second end surface-side outer layer portion 15 are also referred to as L gaps.

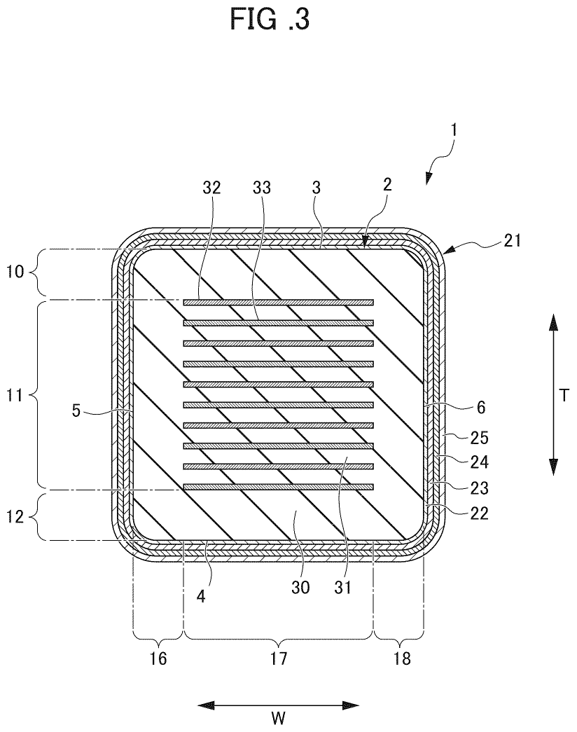

The division of the ceramic base body 2 in the width direction W will be described based on FIG. 3. FIG. 3 is a cross-sectional view taken along the line II-II in FIG. 1. The ceramic base body 2 can be divided into a first lateral surface-side outer layer portion 16, a width direction counter portion 17, and a second lateral surface-side outer layer portion 18 in the width direction W.

The width direction counter portion 17 refers to a portion where the internal electrode layers are opposed to each other in the height direction T. The first lateral surface-side outer layer portion 16 refers to a portion between the width direction counter portion 17 and the first lateral surface 5. The second lateral surface-side outer layer portion 18 refers to a portion between the width direction counter portion 17 and the second lateral surface 6.

The first lateral surface-side outer layer portion 16 and the second lateral surface-side outer layer portion 18 are portions where no internal electrode layers exist in the height direction T. The first lateral surface-side outer layer portion 16 and the second lateral surface-side outer layer portion 18 are also referred to as W gaps.

The internal electrode layers include a plurality of first internal electrode layers 32 and a plurality of second internal electrode layers 33. The first internal electrode layers 32 are exposed at the first end surface 7. The second internal electrode layers 33 are exposed at the second end surface 8.

Each of the first internal electrode layers 32 can be divided into a first counter electrode portion 34 and a first extension electrode portion 36. The first counter electrode portion 34 refers to a portion opposed to a corresponding one of the second internal electrode layers 33. The first extension electrode portion 36 refers to a portion extending from the first counter electrode portion 34 toward the first end surface 7 of the ceramic base body 2.

Each of the second internal electrode layers 33 can be divided into the second counter electrode portion 35 and the second extension electrode portion 37. The second counter electrode portion 35 is a portion that is opposed to a corresponding one of the first internal electrode layers 32. The second extension electrode portion 37 is a portion that extends from the second counter electrode portion 35 to the second end surface 8 of the ceramic base body 2.

The material of the internal electrode layers can be, for example, a metal such as nickel, copper, silver, palladium, or gold. The material of the internal electrode layers can be, for example, an alloy including at least one of these metals, such as a silver-palladium alloy.

In the multilayer ceramic capacitor 1, capacitance is generated by the first counter electrode portion 34 and the second counter electrode portion 35 opposing each other with a corresponding one of the inner dielectric layers 31 interposed therebetween. This enables the multilayer ceramic capacitor 1 to develop capacitor characteristics.

The thickness of each of the internal electrode layers is preferably about 0.2 μm or more and about 2.0 μm or less, for example. The total number of the first internal electrode layers 32 and the second internal electrode layers 33 is, for example, preferably fifteen or more and 2000 or less.

The terminal electrodes will be described. The terminal electrodes include a first terminal electrode 20 and a second terminal electrode 21. The first terminal electrode 20 is connected to the first internal electrode layers 32. The second terminal electrode 21 is connected to the second internal electrode layers 33.

The first terminal electrode 20 is provided on the first end surface 7, a portion of the first main surface 3, a portion of the second main surface 4, a portion of the first lateral surface 5, and a portion of the second lateral surface 6. The second terminal electrode 21 is provided on the second end surface 8, a portion of the first main surface 3, a portion of the second main surface 4, a portion of the first lateral surface 5, and a portion of the second lateral surface 6.

The terminal electrodes each include, for example, a base electrode 22, a resin electrode 23, a nickel plating film 24, and a tin plating film 25. These are provided in the order of the base electrode 22, the resin electrode 23, the nickel plating film 24, and the tin plating film 25 from the end surface of the ceramic base body 2.

The base electrode 22 is provided on the end surface of the ceramic base body 2 and covers the end surface. The base electrode 22 extends from the end surface to a portion of the main surface and a portion of the lateral surface.

The base electrode 22 includes glass and metal. The glass includes, for example, at least one of boron, silicon, barium, magnesium, aluminum, lithium, or the like. The metal includes at least one of, for example, copper, nickel, silver, palladium, silver-palladium alloy, gold, or the like. The base electrode 22 is formed by applying an electrically conductive paste including glass and metal to the ceramic base body 2, and firing the resulting product. The thickness of the base electrode 22 is preferably, for example, about 3 μm or more and about 150 μm or less.

The resin electrode 23 is provided to cover the base electrode 22. The resin electrode 23 includes resin and metal. Since the resin electrode 23 includes resin, it is more flexible than the base electrode 22.

The resin electrode 23 defines and functions as a buffer layer. Therefore, when a deflection stress is applied to the mounting substrate and a physical force is applied to the multilayer ceramic capacitor 1 due to this stress, cracks are less likely to occur in the multilayer ceramic capacitor 1.

In addition, when a force due to thermal cycling is applied to the multilayer ceramic capacitor 1, cracks are less likely to occur in the multilayer ceramic capacitor 1.

The resin included in the resin electrode 23 can be, for example, a thermosetting resin such as epoxy resin, phenol resin, urethane resin, silicone resin, or polyimide resin. Among these resins, epoxy resin is one of the preferable resins. Epoxy resin has excellent heat resistance, moisture resistance, and adhesion. In addition, a plurality of types of resins such as, for example, epoxy resin or phenol resin may be used.

The resin electrode 23 preferably includes a curing agent in addition to the resin. When epoxy resin is used as the resin, the curing agent is, for example, preferably a compound such as a phenol-based compound, amine-based compound, acid anhydride-based compound, imidazole-based compound, active ester-based compound, amidoimide-based compound, or the like.

The resin electrode 23 includes metal. By including metal in the resin electrode 23, the resin electrode 23 is electrically conductive. The metal included in the resin electrode 23 is a metal powder, that is, a filler. The filler included in the resin electrode 23 has a flat shape. The contact between filler particles provides an electrically conductive path inside the resin electrode 23. The electrically conductive path allows the resin electrode 23 to be electrically conductive.

The metal included in the resin electrode 23 can be, for example, silver, copper, nickel, tin, bismuth, or an alloy including these metals. The metal preferably includes silver, for example. The silver may be silver alone. Alternatively, the silver may be an alloy including silver. For example, the metal can be at least one of silver, silver-coated copper, and silver-coated alloy powder.

The nickel plating film 24 is provided so as to cover the resin electrode 23. The tin plating film 25 is provided so as to cover the nickel plating film 24.

The nickel plating film 24 can prevent the resin electrode 23 from being eroded by solder when mounting the multilayer ceramic capacitor 1. The tin plating film 25 can improve the wettability of solder when mounting the multilayer ceramic capacitor 1, thus facilitating mounting.

The size of the multilayer ceramic capacitor 1 is not particularly limited. The preferred length direction dimension of the multilayer ceramic capacitor 1 including the ceramic base body 2 and the terminal electrodes is, for example, about 0.2 mm or more and about 10 mm or less. The preferred height direction dimension of the multilayer ceramic capacitor 1 including the ceramic base body 2 and the terminal electrodes is, for example, about 0.1 mm or more and about 5 mm or less. The preferred width direction dimension of the multilayer ceramic capacitor 1 including the ceramic base body 2 and the terminal electrodes is, for example, about 0.1 mm or more and about 10 mm or less.

In the multilayer ceramic capacitor 1 of the present example embodiment, when stress is applied to the multilayer ceramic capacitor 1, a continuous fracture is likely to occur in the resin electrode 23. Therefore, the stress applied to the multilayer ceramic capacitor 1 is easily released. As a result, cracks are less likely to occur in the ceramic base body 2.

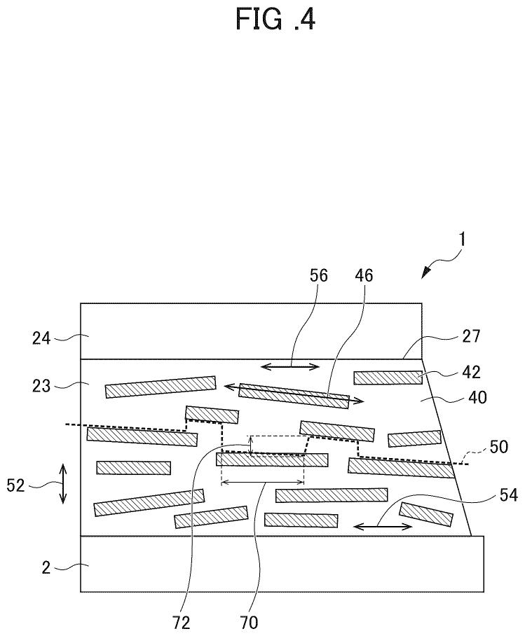

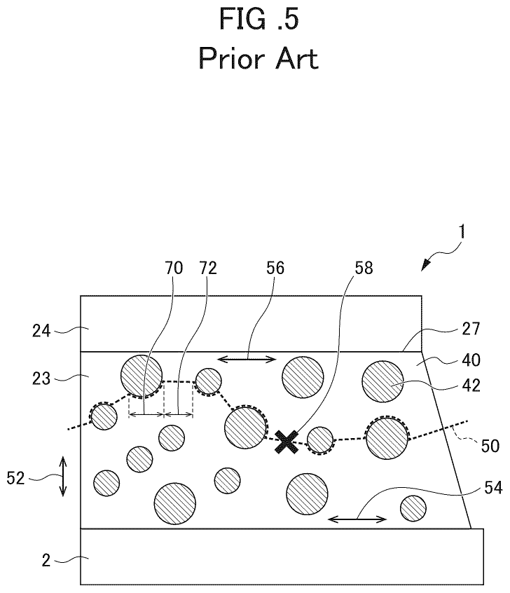

The fracture inside the resin electrode 23 will be described based on FIGS. 4 and 5. FIG. 4 is a conceptual diagram of a cross section of the terminal electrode of the present example embodiment. FIG. 5 is a conceptual diagram of a cross section of a conventional terminal electrode.

The arrows 52 illustrated in FIGS. 4 and 5 indicate the thickness direction of the resin electrode 23. FIGS. 4 and 5 each show a cross section in a direction parallel or substantially parallel to the thickness direction 52 of the resin electrode 23. The arrows 54 illustrated in FIGS. 4 and 5 indicate a direction parallel or substantially parallel to a surface of the ceramic base body 2. The arrows 56 illustrated in FIGS. 4 and 5 indicate a direction along a surface 27 which is the outer surface of the resin electrode 23. When the nickel plating film 24 is provided on the surface 27 of the resin electrode 23, the arrow 56 indicates a direction along the inner surface of the nickel plating film 24. The broken lines 50 illustrated in FIGS. 4 and 5 indicate a fracture occurring in the resin electrode 23.

The filler 42 included in the resin electrode 23 of the present example embodiment has a flat shape. Further, the average aspect ratio of the filler 42 is, for example, about 4 or more. Therefore, as shown in FIG. 4, the filler 42 is observed in a rectangular or substantially rectangular shape in a cross section in a direction parallel or substantially parallel to the thickness direction 52 of the resin electrode 23. The longitudinal direction of this rectangular or substantially rectangular shape is indicated by the arrow 46. The longitudinal direction 46 of the observed rectangular or substantially rectangular shape approximately corresponds to the direction 54 of the surface of the ceramic base body 2 or the direction 56 along the surface of the nickel plating film 24.

As shown in FIG. 4, in the resin electrode 23 of the present example embodiment, the broken line 50 indicating a fracture extends along the direction 54 or the direction 56.

This is because the fracture propagates along the surfaces of the plurality of filler particles 42. In the resin electrode 23 of the present example embodiment, the filler 42 has a flat shape. Further, the longitudinal direction 46 of each of the filler particles 42 is aligned toward the direction 54 of the surface of the ceramic base body 2 or the direction 56 along the surface of the nickel plating film 24. Therefore, the fracture is likely to connect along the longitudinal direction 46 of the filler 42.

Further, the average particle size of the filler 42 included in the resin electrode 23 of the present example embodiment is, for example, about 5 μm or more. Therefore, it is possible to reduce the proportion of the resin portion in the fracture path. As a result, it is possible to reduce or prevent the interruption of the propagation of fractures. This will be described below.

The arrow 70 in FIG. 4 indicates the distance of the portion where the fracture propagates along the filler 42. The arrow 72 in FIG. 4 indicates the distance of the portion where the fracture propagates through the resin 40.

In the resin electrode 23 of the present example embodiment, the directions of the longitudinal direction 46 of the filler 42 are aligned, and the average particle size is, for example, about 5 μm or more. Therefore, it is possible to increase the proportion of the portion 70 where the fracture propagates along the filler 42 in the fracture path. In other words, it is possible to reduce the proportion of the portion 72 where the fracture propagates through the resin 40.

The fracture is less likely to be interrupted in the portion where it propagates along the filler 42. On the other hand, the fracture is likely to be interrupted in the portion where it propagates through the resin 40. In the present example embodiment, the proportion of the portion 70 where the fracture propagates along the filler 42 is large, and it is possible to reduce the proportion of the portion 72 where the fracture propagates through the resin 40. Therefore, it is possible to increase the length of the fracture without the fracture being interrupted midway.

The fracture in the present example embodiment is, for example, about 5 μm or more after the substrate bending crack test described later.

In contrast, in the conventional resin electrode 23, even if a fracture occurs, the fracture is less likely to propagate. This will be explained based on FIG. 5. As a conventional example, a resin electrode 23 using spherical filler particles 42 will be explained. As shown in FIG. 5, when the filler particles 42 each have a spherical shape, the filler particles 42 do not have any particular orientation with respect to the direction 54 of the surface of the ceramic base body 2 or the direction 56 along the surface of the nickel plating film 24.

The arrow 70 in FIG. 5 indicates the distance of the portion where the fracture propagates along the filler 42, similar to FIG. 4. The arrow 72 in FIG. 5 indicates the distance of the portion where the fracture propagates through the resin 40, similar to FIG. 4.

As shown in FIG. 5, in the conventional resin electrode 23, compared to the resin electrode 23 of the present example embodiment shown in FIG. 4, the length of the portion 70 where the fracture propagates along the filler 42 is shorter, and the length of the portion 72 where the fracture propagates through the resin 40 is longer. Therefore, in the portion where the fracture propagates through the resin 40, the fracture is likely to be interrupted. For example, at locations where the length of the portion 72 where the fracture propagates through the resin 40 is long, such as the X mark 58 illustrated in FIG. 5, the propagation of the fracture is likely to be interrupted. Therefore, long fractures are less likely to propagate. As a result, stress release at the terminal electrode is less likely to propagate, and cracks are more likely to occur in the ceramic base body 2.

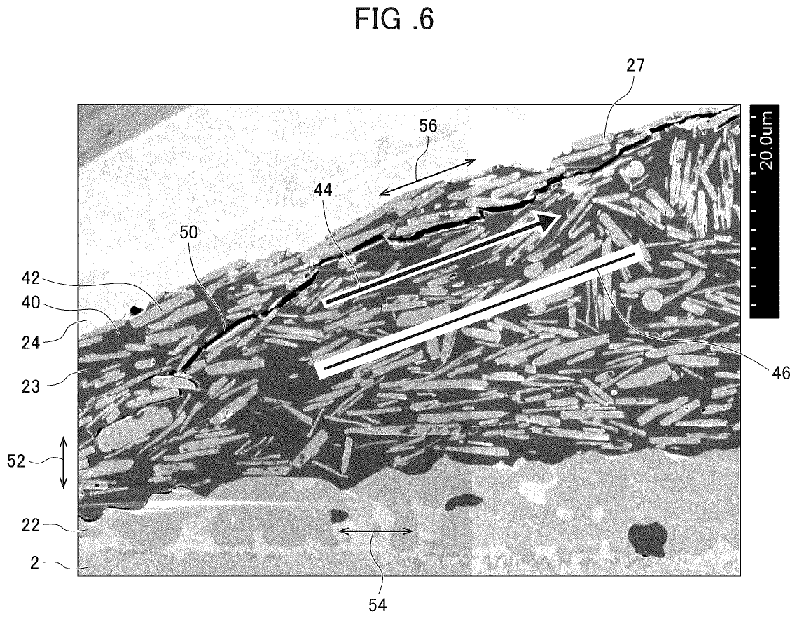

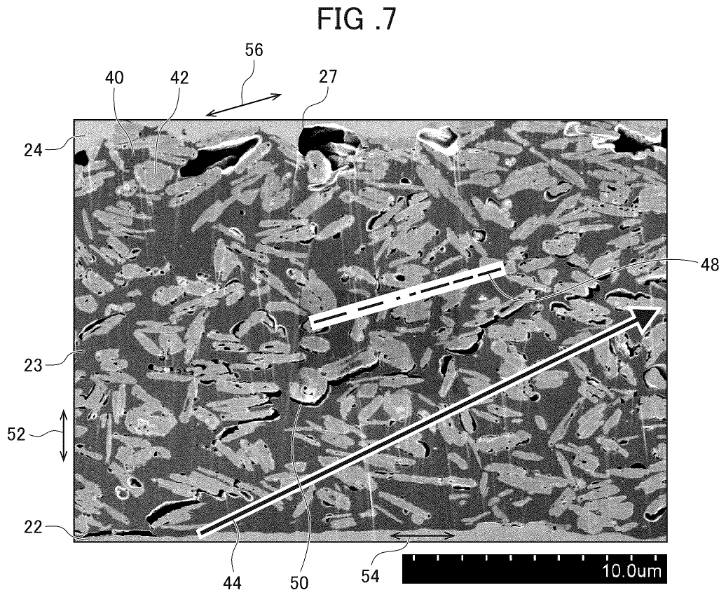

The propagation of the fracture will be explained more specifically based on FIGS. 6 and 7. FIG. 6 is a diagram showing a scanning electron microscope image of a cross section of the terminal electrode of the present example embodiment. FIG. 7 is a diagram showing a scanning electron microscope image of a cross section of a conventional terminal electrode. FIGS. 6 and 7 both show the state after the substrate bending crack test described later.

As shown in FIG. 6, in the resin electrode 23 of the present example embodiment, the filler particles 42 are oriented in the direction 54 of the surface of the ceramic base body 2 in the vicinity of the interface with the ceramic base body 2. Further, the filler particles 42 are oriented in the direction 56 along the surface of the nickel plating film 24 in the vicinity of the surface 27 of the resin electrode 23.

Then, the fracture 50 continuously propagates within the resin electrode 23, as shown in FIG. 6. The arrow 44 in FIG. 6 indicates the direction of propagation of the fracture 50.

FIG. 6 shows the fracture 50 in the vicinity of the surface 27 of the resin electrode 23. The fracture 50 can also occur in the vicinity of the interface between the resin electrode 23 and the ceramic base body 2.

In addition, the vicinity of the interface or the vicinity of the surface refers to, for example, a range of about 5 μm from the interface or surface.

In contrast, in a conventional terminal electrode, the fracture 50 does not propagate continuously within the resin electrode 23. As shown in FIG. 7, the fracture 50 propagates in the propagation direction 44 of the fracture 50, but is interrupted. The line 46 in FIG. 6 and the line 48 in FIG. 7 are lines drawn along the fracture 50, respectively. As shown by the line 46 in FIG. 6, in the present example embodiment, the line 46 indicating the fracture 50 is continuous. In contrast, as shown by the line 48 in FIG. 7, the line 48 indicating the fracture 50 in the conventional resin electrode 23 is discontinuous.

TABLE 1

| | | | | Comparative | Comparative | Comparative |
|---|---|---|---|---|---|---|
| | Example 1 | Example 2 | Example 3 | Example 1 | Example 2 | Example 3 |
| Particle | 5.0 | 6.8 | 5.0 | 2.4 | 4.5 | 5.1 |
| size[μm] | | | | | | |
| Aspect ratio | 4.0 | 7.1 | 4.0 | 2.1 | 4.0 | 3.7 |
| Ratio of | 70 | 80 | 70 | 51 | 72 | 71 |
| filler | | | | | | |
| oriented along | | | | | | |
| the interface | | | | | | |
| near the | | | | | | |
| interface | | | | | | |
| [%] | | | | | | |
| Inter-filler | 1.0 | 3.0 | 3.0 | 3.0 | 2.9 | 3.0 |
| distance in the | | | | | | |
| direction | | | | | | |
| perpendicular | | | | | | |
| to the ceramic | | | | | | |
| element | | | | | | |
| surface[μm] | | | | | | |
| Degree of | 30 | 19 | 30 | 40 | 30 | 28 |
| orientation[°] | | | | | | |
| Thermal shock | 0 | 0 | 0 | 2 | 0 | 0 |
| crack | | | | | | |
| test[pieces, | | | | | | |
| n = 20] | | | | | | |
| Mechanical | 0 | 0 | 0 | 3 | 1 | 1 |
| strength | | | | | | |
| test[pieces, | | | | | | |
| n = 20] | | | | | | |

Based on Table 1, the particle size of the filler particles 42 and the results of the crack occurrence test will be explained. First, the measurement method and test method will be explained.

The particle size shown in Table 1 is the D50 average particle size of the filler particles 42. The aspect ratio is the major axis diameter/minor axis diameter of the filler particles 42.

The particle size and aspect ratio are average values obtained by analyzing scanning electron microscope images.

The scanning electron microscope image is the result of observing the LT cross section of the second terminal electrode 21 in a range of about 50 μm×about 80 μm in a state polished in the width direction W to the center position in the width direction W.

The ratio of the filler particles 42 oriented in the direction along the interface near the interface is the ratio of the filler particles 42 oriented in the direction along the surface 27 or the interface with the ceramic base body 2 within a range of about 5 μm from the surface 27 facing the nickel plating film 24 and within 5 about μm from the interface with the ceramic base body 2. Here, “along” indicates that the angle between the longitudinal direction of the filler 42 and the surface 27 or the interface with the ceramic base body 2 is, for example, about 10 degrees or less.

The inter-filler distance in the direction perpendicular or substantially perpendicular to the ceramic base body surface refers to the distance between each filler particle 42 and the filler particle 42 having the shortest distance in the perpendicular or substantially perpendicular direction.

The ratio of the filler particles 42 oriented in the direction along the interface near the interface and the inter-filler distance in the direction perpendicular or substantially perpendicular to the ceramic base body surface are average values obtained by analyzing scanning electron microscope images similar to those used for particle size measurement.

The degree of orientation is a value obtained by analyzing SEM images with image analysis software.

The thermal shock crack test was conducted under the following conditions. One cycle including holding the test sample chips in a temperature range of about +0° C. or less and about −3° C. or more of the minimum operating temperature for about 30 minutes, and then holding them in a temperature range of about +3° C. or less and about −0° C. or more of the maximum operating temperature for about 30 minutes, and this temperature cycle was performed for 1000 cycles. The maximum operating temperature and minimum operating temperature refer to the upper and lower limits of the operating temperature range of the multilayer ceramic capacitor, respectively. These temperatures vary depending on the product. In the thermal shock crack test shown in Table 1, for example, the maximum operating temperature was about 125° C. and the minimum operating temperature was about −55° C. However, the temperature settings in the thermal shock crack test are not limited to these. After performing the predetermined cycles, cracks were confirmed by observing the polished cross section of the chips after testing.

The substrate bending crack test conformed to JIS C 5101. Specifically, the multilayer ceramic capacitor 1 was mounted on a substrate having a thickness of about 1.6 mm. Thereafter, the R1 jig substrate was bent to about 5 mm and held for about 60 seconds.

In the thermal shock crack test and the substrate bending crack test, when a crack extends to the effective portion 11 of the ceramic base body 2, it was determined that there was a crack. This is because when a crack extends to the effective portion 11, the internal electrode layers may short-circuit and the multilayer ceramic capacitor 1 may fail.

The numbers of samples for the thermal shock crack test and the substrate bending crack test were twenty each.

The occurrences of cracks after the thermal shock crack test and the substrate bending crack test were confirmed by observing the LT cross-section of the ceramic base body 2 in a state where it was polished in the width direction W to the center position in the width direction W. In addition, the average length of cracks in the resin electrode 23 after the substrate bending crack test was determined by analyzing scanning electron microscope images of the resin electrode 23 of the second terminal electrode 21.

As shown in Table 1, when the particle size of the filler particles 42 is about 5.0 μm or more and the aspect ratio is about 4.0 or more, no cracks occurred after the thermal shock crack test and the substrate bending crack test.

It is preferable that the filler particles 42 are oriented as follows. That is, for example, it is preferable that about 70% or more of the filler particles 42 near the interface between the resin electrode 23 and the ceramic base body 2 has an angle of about 10° or less between the longitudinal direction 46 of the filler 42 and the interface with the ceramic base body 2. This makes it possible to more reliably propagate the fracture of the resin electrode 23.

Similarly, for example, it is preferable that about 70% or more of the filler particles 42 near the outer surface 27 of the resin electrode 23 has an angle formed by the longitudinal direction 46 of the filler 42 and the surface 27 of about 10° or less. This makes it possible to more reliably propagate the fracture of the resin electrode 23.

In addition, for example, it is preferable that the average length of cracks in the resin electrode 23 after the substrate bending crack test is about 5 μm or more. This makes it possible to more reliably reduce or prevent the occurrence of cracks in the ceramic base body 2.

In addition, as shown in Table 1, for example, it is preferable that the degree of orientation of the filler particles 42 is about 30 degrees or less, and the interparticle distance of the filler particles 42 is about 3 μm or less. In particular, for example, it is preferable that the interparticle distance of the filler particles 42 is about 3 μm or less in the direction perpendicular or substantially perpendicular to the ceramic base body surface.

When the degree of orientation of all of the filler particles 42 in the resin electrode 23 is about 30 degrees or less and the interparticle distance is about 3 μm or less, cracks, that is, the fracture 50, are more likely to propagate in the resin electrode 23.

This is due to the following reasons. The resin electrode 23 includes the metal filler particles 42 and the resin 40. In such a resin electrode 23, the order of sites where the fracture 50 is likely to progress is as follows. The first is the interface between the resin 40 and the filler particles 42, the second is within the resin 40, and the third is within the filler particles 42. However, the fracture 50 rarely propagates within the filler 42. The fracture 50 mainly propagates at the interface between the resin 40 and the filler particles 42 and within the resin 40.

Therefore, by maximizing the proportion of the interface between the resin 40 and the filler particles 42 in the propagation distance of the fracture 50, the fracture 50 is more likely to propagate.

When the filler particles 42 are oriented in a certain direction, the fracture 50 is likely to progress along the interface between the resin 40 and the filler particles 42. This is because the directions in which the interfaces between the resin 40 and the filler particles 42 extend are likely to be aligned.

As the degree of orientation of the filler particles 42 with respect to the ceramic base body 2 becomes smaller, the filler particles 42 are oriented more in a constant direction. Therefore, when the degree of orientation is equal to or less than a certain angle, the fracture 50 is more likely to progress.

In addition, by minimizing the proportion of the fracture 50 within the resin 40 relative to the propagation distance of the fracture 50, the fracture 50 is more likely to propagate. In order to reduce the fracture 50 within the resin 40, it is important to reduce the distance between the filler particles 42. Therefore, when the inter-particle distance is equal to or less than a certain value, the fracture 50 is more likely to progress.

An example of a method for measuring the length and thickness of each portion other than the above-described measurement method will be described. The multilayer ceramic capacitor 1 is polished to the middle position in the width direction W. Then, the LT cross section exposed by polishing is observed with an optical microscope or the like. From the observed LT cross section, the length or thickness can be measured.

An example of a method for manufacturing a multilayer ceramic capacitor 1 according to an example embodiment of the present invention will be described. Dielectric sheets and electrically conductive paste for manufacturing internal electrode layers are prepared. The dielectric sheets and the electrically conductive paste for manufacturing internal electrode layers include a binder and a solvent. The binder and the solvent may be a known organic binder and organic solvent.

The electrically conductive paste for manufacturing internal electrode layers is printed on the dielectric sheet in a predetermined pattern. The internal electrode layer pattern is formed by printing the electrically conductive paste. The printing can be performed by, for example, screen printing or gravure printing.

A predetermined number of dielectric sheets for manufacturing the outer layer portion are laminated. No internal electrode layer pattern is printed on the dielectric sheets for manufacturing the outer layer portion. Dielectric sheets with printed internal electrode layer patterns are sequentially laminated on the laminated dielectric sheets. Furthermore, a predetermined number of dielectric sheets for manufacturing the outer layer portion are laminated thereon. A multilayer sheet is produced by these lamination processes.

A multilayer block is manufactured by pressing the multilayer sheet in the height direction. A hydrostatic press, for example, can be used for the pressing method.

The multilayer block is cut to a predetermined size. Multilayer chips are cut out by this cutting. The corner portions and ridge portions of each of the multilayer chips may be rounded during cutting. Barrel polishing, for example, can be used as the method for rounding.

The multilayer chips are fired. Ceramic base bodies are manufactured by this firing. The preferable firing temperature is, for example, about 900° C. or more and about 1110° C. or less. The firing temperature can be changed according to the materials of the dielectric and the internal electrode layer.

Terminal electrodes are formed. First, an electrically conductive paste that will become the base electrode 22 to the two end surfaces of the ceramic base body 2 is applied. The electrically conductive paste includes glass and metal. The electrically conductive paste can be applied by methods such as dipping, for example. After application, firing is performed to form the base electrode 22. The firing temperature is, for example, preferably about 500° C. or more and about 900° C. or less. Further, the firing time is, for example, preferably about 30 minutes or more and about 2 hours or less.

The resin electrode 23 is formed on the base electrode 22. An electrically conductive resin paste is prepared. The electrically conductive resin paste includes, for example, resin, metal, and a solvent. The electrically conductive resin paste is applied on the base electrode 22. The application method can be dipping, for example.

In the electrically conductive resin paste, the average aspect ratio of the filler is, for example, about 4 or more. Further, the amount of filler added is such that the volume ratio of the filler is, for example, about 40% by volume or more. The viscosity of the electrically conductive resin paste is, for example, preferably about 1 Pa's or more to about 50 Pa·s.

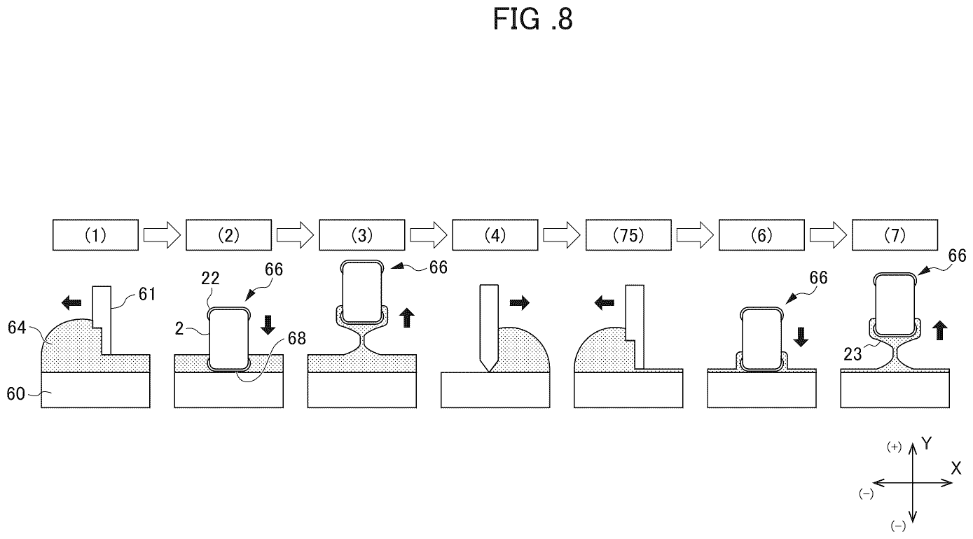

An example of a method for forming the resin electrode 23 will be specifically described based on FIG. 8. FIG. 8 is a diagram sequentially showing each operation in forming the resin electrode 23. In (1), the thickness of the electrically conductive resin paste 64 provided on the plate 60 is made uniform by moving the blade 61 in the negative direction of the X-axis.

A chip 66 is defined as the ceramic base body 2 on which the base electrode 22 is formed. In (2), the chip 66 is immersed in the electrically conductive resin paste 64. Specifically, the chip 66 is moved in the negative direction of the Y-axis to press the application surface 68 against the plate 60.

In (3), the chip 66 is moved in the positive direction of the Y-axis. When pulling up, the pulling speed is increased. The pulling speed is, for example, preferably about 0.7 mm/s or more, and more preferably about 1.0 mm/s or more.

In (4), the electrically conductive resin paste 64 remaining on the plate 60 is removed using the squeegee 62. Specifically, the squeegee 62 is moved in the positive direction of the X-axis while the squeegee 62 is in contact with the plate 60.

In (5), the thickness of the electrically conductive resin paste 64 newly provided on the plate 60 is made uniform by moving the blade 61 in the negative direction of the X-axis. The thickness of the electrically conductive resin paste 64 after being made uniform is made thinner than the thickness in (1). The thickness of the electrically conductive resin paste 64 in (5) is, for example, preferably about 50 μm or less, and more preferably about 30 μm or less.

In (6), scraping is performed. Specifically, the chip 66 is moved in the negative direction of the Y-axis, and the application surface 68 is pressed against the plate 60. In addition, in (4), the electrically conductive resin paste 64 may be removed from the plate 60, and in (6), the application surface 68 may be pressed against the plate 60 on which the electrically conductive resin paste 64 is not provided. In this case, operation (5) can be omitted.

In (7), the chip 66 is moved in the positive direction of the Y-axis. When moving the chip 66, the pulling speed is increased. The pulling speed is, for example, preferably about 0.7 mm/s or more, and more preferably about 1.0 mm/s or more. Through the above, the application of the electrically conductive resin paste 64 is completed.

After the application, heat treatment is performed. As the heat treatment, drying is performed at, for example, about 150° C. or more and about 180° C. or less for about 10 minutes in a hot air oven. Thereafter, curing is performed at, for example, about 200° C. or more and about 280° C. or less for about 60 minutes in an air atmosphere. The resin electrode 23 is formed by this heat curing.

A nickel plating film 24 is formed on the surface of the resin electrode 23. Furthermore, a tin plating film 25 is formed on the surface of the nickel plating film 24. The nickel plating film 24 and the tin plating film 25 can be formed by, for example, a barrel plating method or the like. In this way, the multilayer ceramic capacitor 1 is obtained.

Although example embodiments of the present invention have been described above, the present invention is not limited to the above-described example embodiments, and various changes and modifications thereto are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic base body including a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction; and
terminal electrodes each located on the ceramic base body and each connected to some of the plurality of internal electrode layers; wherein
each of the terminal electrodes includes a resin electrode including a resin and an electrically conductive filler;
an average particle size of the electrically conductive filler is about 5 μm or more; and
an average aspect ratio of the electrically conductive filler is about 4 or more.

2. The multilayer ceramic capacitor according to claim 1, wherein
a degree of orientation of the electrically conductive filler is about 30 degrees or less; and
an interparticle distance of the electrically conductive filler is about 3 μm or less.

3. The multilayer ceramic capacitor according to claim 1, wherein about 70% or more of the electrically conductive filler in a vicinity of an interface between the resin electrode and the ceramic base body in the resin electrode has an angle between a longitudinal direction of the electrically conductive filler and the interface of about 10° or less.

4. The multilayer ceramic capacitor according to claim 1, wherein about 70% or more of the electrically conductive filler particles in a vicinity of an outer surface of the resin electrode has an angle between a longitudinal direction of the electrically conductive filler and the outer surface of about 10° or less.

5. The multilayer ceramic capacitor according to claim 1, wherein an average crack length in the resin electrode after a substrate bending crack test is about 5 μm or more.

6. The multilayer ceramic capacitor according to claim 1, wherein each of the plurality of dielectric layers includes barium titanate, calcium titanate, strontium titanate, or calcium zirconate as a main component.

7. The multilayer ceramic capacitor according to claim 6, wherein each of the plurality of dielectric layers includes manganese compounds, iron compounds, chromium compounds, cobalt compounds, or nickel compounds as a sub-component.

8. The multilayer ceramic capacitor according to claim 1, wherein a thickness of each of the plurality of dielectric layers is about 0.3 μm or more and about 10 μm or less.

9. The multilayer ceramic capacitor according to claim 1, wherein each of the plurality of internal electrode layers includes nickel, copper, silver, palladium, or gold.

10. The multilayer ceramic capacitor according to claim 1, wherein a thickness of each of the plurality of internal electrode layers is about 0.2 μm or more and about 2.0 μm or less.

11. The multilayer ceramic capacitor according to claim 1, wherein the terminal electrodes include a base electrode layer, the resin electrode, a nickel plating film, and a tin plating film arranged in this order.

12. The multilayer ceramic capacitor according to claim 1, wherein the resin included in the resin electrode includes epoxy resin, phenol resin, urethane resin, silicone resin, or polyimide resin.

13. The multilayer ceramic capacitor according to claim 1, wherein the resin electrode includes a curing agent.

14. The multilayer ceramic capacitor according to claim 13, wherein the curing agent includes a phenol-based compound, amine-based compound, acid anhydride-based compound, imidazole-based compound, active ester-based compound, or amidoimide-based compound.

15. The multilayer ceramic capacitor according to claim 1, wherein the electrically conductive filter included in the resin electrode has a flat shape.

16. The multilayer ceramic capacitor according to claim 1, wherein the electrically conductive filter included in the resin electrode includes silver, copper, nickel, tin, or bismuth, or an alloy including silver, copper, nickel, tin, or bismuth.

17. The multilayer ceramic capacitor according to claim 1, wherein the electrically conductive filler has a rectangular or substantially rectangular shape in a cross section in a direction parallel or substantially parallel to a thickness direction of the resin electrode.

18. The multilayer ceramic capacitor according to claim 1, wherein
a length direction dimension of the multilayer ceramic capacitor including the ceramic base body and the terminal electrodes is about 0.2 mm or more and about 10 mm or less;
a height direction dimension of the multilayer ceramic capacitor including the ceramic base body and the terminal electrodes is about 0.1 mm or more and about 5 mm or less; and
a width direction dimension of the multilayer ceramic capacitor including the ceramic base body and the terminal electrodes is about 0.1 mm or more and about 10 mm or less.
